(19) United States
(12) Patent Application Publication
(10) Pub. No.: US 2006/0248943 A1
(43) Pub. Date: Nov. 9, 2006

(54) Method of Measuring Density of a Grain Sample

(75) Inventor: Robert C. Funk, Auburn, IL (US)

Correspondence Address: ALBIHNS STOCKHOLM AB, BOX 5581, LINNEGATAN 2, SE-114 85 STOCKHOLM; SWEDENn, STOCKHOLM, SE

(73) Assignee: Perten Instruments Inc., Springfield, IL (US)

(21) Appl. No.: 11/382,962

(22) Filed: May 12, 2006

Related U.S. Application Data
(62) Division of application No. 10/710,474, filed on Jul. 14, 2004.

(51) Int. Cl. G01N 9/02

(52) U.S. Cl. 73/32 R; 73/433

(57) ABSTRACT

A method of determining density of grains, comprises the steps of: (a) filling a test cell (3) having a known volume with an excess of grains, (b) removing the excess grains from the test cell (3), (c) gathering the removed excess of grains in a container (4) having a known weight when empty, (d) weighing the container (4) together with the excess of grains, (e) filling the container (4) with grains from the test cell (3) after the step of weighing the container (4) together with the excess of grains has been performed and weighing the container (4) together with its content of grains, and (f) determining a correction factor for the density of said grains. This factor is dependent on the weight of the excess grains, and permits precise calculation the density of the grains.

### CROSS-REFERENCE TO RELATED APPLICATION

The present application is a divisional application pursuant to 35 U.S.C.§121 having complete benefit of U.S. patent application Ser. No. 10/710,474 as originally filed on 14 Jul. 2004

Grain, such as cereals, oilseeds and seeds, is bought and sold on the basis of weight. However, the actual value of the grains is in a dry state, which means that the moisture content of the grains must be taken account of when determining the price for a certain lot of grains. Furthermore, if the moisture content is above a certain value the risk for deterioration of the grains due to microbial activity makes it necessary to dry the grains before storage thereof. It is thus essential to be able to determine the moisture content of grains in an easy and accurate way.

Grain moisture meters based on the radio-frequency (RF) dielectric method measure moisture content in grain by sensing the dielectric constant of grain samples. However, it has been shown that grain kernel structure and composition and moisture distribution within kernels greatly influence the measurements, thereby making it necessary for individual calibration equations for different grain types and limiting the measurement accuracy. In “An investigation of the nature of the radio-frequency dielectric response in cereal grains and oilseeds with engineering implications for grain moisture meters” presented to the faculty of the University of Missouri-Kansas City by David. B. Funk it is shown that the RF-method can be used with the same calibration equations for all types of grains if measurement frequencies in the range 100-200 MHz are used instead of the commonly used range 1-20 MHz.

The accuracy of obtained moisture content values calculated from the measured dielectric constant of a grain sample introduced into a grain moisture meter is dependent several factors, such as temperature and grain density.

The objective of the present invention is to improve the accuracy of density measurement.

The present invention relates to a method of determining density of a grain sample, comprising the steps of:

filling a test cell having a known volume with an excess of grains,

removing the excess of grains from the test cell,

gathering the removed excess grains in a container having a known weight when empty,

weighing the container together with the excess grains,

filling the container with grains from the test cell after the step of weighing the container together with the excess grains has been performed and weighing the container together with its content of grains,

determining a correction factor for the density of the grains, said factor being dependent on the weight of the excess grains, and

calculating the density of the grains.

The invention will now be described with reference to the enclosed FIGURE, of which;

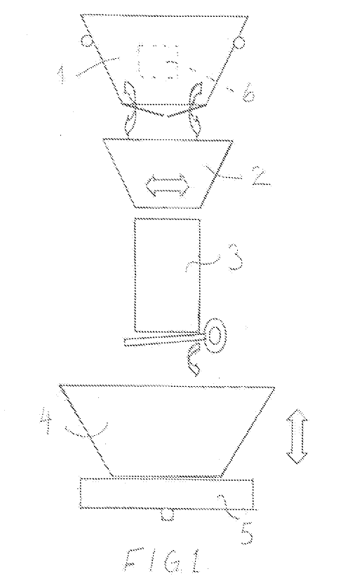

FIG. 1 schematically discloses a side view of an embodiment of a grain moisture meter illustrative of the invention

### DESCRIPTION OF EMBODIMENTS

The grain moisture meter shown in FIG. 1 comprises a top hopper 1, a strike off element 2, a test cell 3 and a container 4 disposed on a balance 5.

The top hopper 1 functions to hold a grain sample during a temperature measurement thereof and then emptying the grain sample into a test cell 3 via a funnel element 2 provide with a strike off element 7. In order to measure the temperature of the grain sample, a temperature meter 6 is disposed in the top hopper 1.

Such a temperature meter will have an area of about 25 square cm and will therefore be in contact with a great number of grains. This is advantageous for obtaining an accurate average overall sample temperature, particularly if the sample has been blended from various points within a truck or bin before it is filled into the top hopper 1.

After the temperature of a grain sample in the top hopper 1 has been measured the bottom of the hopper is opened by any suitable mechanism and die grain sample is emptied into the test cell 3 having an open top. On its way to the test cell 3, the grain sample is guided by a funnel element 2.

The grain moisture meter suitable for carrying out the present invention preferably comprises means (not shown in the figures) for transporting the container 4 from a delivery position, in which the container is accessible to an operator of the meter, to a loading position, in which the container is disposed on the load cell platform 5 or other types of weighing means and inaccessible to an operator of the meter. Thereby it is ensured that an operator of the meter can not influence the weight readings and that the container will be gently transferred to the load cell platform. The transport means can be a lift mechanism lowering the container 4 gently onto the platform 5 or any other suitable transport mechanism, as indicated by a double arrow in FIG. 1.

An electronic tilt sensor is preferably monitoring the orientation of the grain moisture meter. Thereby, small deviations from a vertical orientation of the load cells can be compensated for mathematically, thereby eliminating the need for adjustable levelling feet on the meter.

The grain moisture meter comprises also a CPU or the like for controlling the different measurements steps and for performing the required calculations. This CPU can be a separate computer connected to the rest of the meter or a CPU integral with the rest of the meter.

The described apparatus can of course be modified in several ways without the method falling outside the scope of invention. For example, instead of a separate blade 7, the strike off element can be the funnel 2, the funnel 2 then being moveable in a transverse direction from a central position. An advantage with such a construction is that the excess of grain sample will be fairly evenly distributed in the container 4. Furthermore, instead of swingable doors to open the bottoms of top hopper 1 and/or the test cell 3, slidable doors can be used. If slidable doors are used for the top container 1, the funnel element 2 can be deleted, a separate strike off element then be used or the top hopper being moveable in a transverse direction to function also as a strike off element. Other temperature meters than the meter 6 can of course be used for measuring the temperature of the grain sample. The scope of protection shall therefore only be determined by the wording of the enclosed patent claim.

1. Method of determining density of grains, comprising the steps of: (a) filling a test cell having a known volume with an excess of grains, (b) removing the excess of grains from the test cell, (c) gathering the removed excess of grains in a container having a known weight when empty, (d) weighing the container together with the excess of grains, (e) filling the container with grains from the test cell after the step of weighing the container together with the excess of grains has been performed and weighing the container together with its content of grains, (f) determining a correction factor for the density of said grains, said factor being dependent on the weight of the excess of grains, and (g) calculating the density of the grains.
